(19) United States
(12) Patent Application Publication
(10) Pub. No.: US 2004/0205816 A1
(43) Pub. Date: Oct. 14, 2004

(54) Virtual channel preview guide

(76) Inventor: Peter T. Barrett, San Francisco, CA (US)

Correspondence Address: LEE & HAYES PLLC, 421 W RIVERSIDE AVENUE SUITE 500, SPOKANE, WA, 99201

(21) Appl. No.: 10/412,560

(22) Filed: Apr. 11, 2003

(51) Int. Cl. G06F 3/00; H04N 7/16; H04N 7/173; H04N 5/445; G06F 13/00

(52) U.S. Cl. 725/49; 725/134; 725/139; 725/131; 725/151

(57) ABSTRACT

In an implementation of virtual channel preview guide, a different virtual channel is associated with each of one or more recorded programs. A virtual channel preview guide is generated to display the different virtual channels and the associated recorded programs. In an event that a virtual channel is selected, a preview of a recorded program associated with the virtual channel is initiated.

### TECHNICAL FIELD

This invention relates to recorded program content and, in particular, to a virtual channel preview guide for recorded broadcast programs and on-demand programs and content.

### BACKGROUND

A client device in a television-based system, such as a set-top box or a digital video recorder, can receive video content from a program distributor in the form of video on-demand movies and programs, and in the form of broadcast programs which include news shows, sitcoms, movies, commercials, and any other form of television-based entertainment and information. A client device that includes a hard disk memory can be utilized to record the video on-demand and broadcast programs of interest to a viewer.

The recorded broadcast programs maintained with a hard disk memory in a client device, as well as the video on-demand programs which may also be recorded or available from a program provider, are typically accessible via user interfaces at the client device that lists the recorded or video on-demand programs for selection by the viewer. A scroll list of available recorded or video on-demand programs only provides a list of the programs and does not provide an intuitive, user-friendly interface to determine which of the many programs may be of interest to the viewer. Further, a scroll list of the recorded or video on-demand programs only provides limited program information, such as the program name.

Accordingly, for television-based entertainment and information systems that are implemented to record video on-demand and broadcast programs, as well as provide a user interface for selecting recorded broadcast and/or video on-demand programs, there is a need for an informative and user-friendly user interface.

### SUMMARY

A virtual channel preview guide is described herein.

In an implementation, a different virtual channel is associated with each of one or more recorded programs. A virtual channel preview guide is generated to display the different virtual channels and the associated recorded programs. In an event that a virtual channel is selected, a preview of a recorded program associated with the virtual channel is initiated.

In another implementation, a virtual channel preview guide includes program identifiers that each correspond to a recorded program, and includes virtual channel identifiers that are each associated with a different program identifier. The virtual channel preview guide also includes a selectable control, such as a program identifier or a virtual channel identifier, that can be selected to initiate a preview of a recorded program. The virtual channel preview guide includes a preview display to display the preview of the recorded program.

### BRIEF DESCRIPTION OF THE DRAWINGS

The same numbers are used throughout the drawings to reference like features and components.

FIG. 1 illustrates various components of an exemplary system to implement a virtual channel preview guide.

FIG. 2 illustrates an example of a program preview initiated from a virtual channel preview guide.

FIG. 3 illustrates an exemplary program guide that includes a section of a virtual channel preview guide.

FIG. 4 illustrates an exemplary section of a virtual channel preview guide.

FIG. 5 is a flow diagram that illustrates an exemplary method for a virtual channel preview guide.

FIG. 6 illustrates various components of an exemplary client device implemented in a television-based system.

FIG. 7 illustrates an exemplary system architecture in which a virtual channel preview guide can be implemented.

FIG. 8 illustrates an exemplary broadcast video distribution architecture in which a virtual channel preview guide can be implemented.

FIG. 9 further illustrates components of the exemplary broadcast video distribution architecture shown in FIG. 8.

### DETAILED DESCRIPTION

Television viewing is increasingly “on-demand” and the use of digital video recorders, personal video recorders, and video on-demand program playback systems are shifting viewing habits from having to watch broadcast programs at programming times scheduled by a provider of the programs to being able to watch pre-recorded broadcast and/or on-demand programs and content at a time convenient for a viewer. In an implementation of a virtual channel preview guide, recorded programs, to include recorded broadcast programs, recorded video on-demand programs, and any other type of recorded on-demand content, are displayed in the virtual channel preview guide that is an intuitive and user-friendly interface to preview the many available recorded programs and content. Selecting a virtual channel, or an associated recorded program identifier, initiates a preview of the recorded program so that a viewer can determine whether to initiate rendering the recorded program for viewing.

The following discussion is directed to television-based entertainment and information systems, such as a two-way unicast network, interactive television networks, cable networks, and Web-enabled television networks. Client devices in such systems range from full-resource clients with substantial memory and processing resources, such as television-enabled personal computers and television recorders equipped with hard-disks, to low-resource clients with limited memory and/or processing resources, such as traditional set-top boxes that are also implemented to record broadcast programs. While aspects of the described systems and methods can be used in any of these systems and for any types of client devices, they are described in the context of the following exemplary environment.

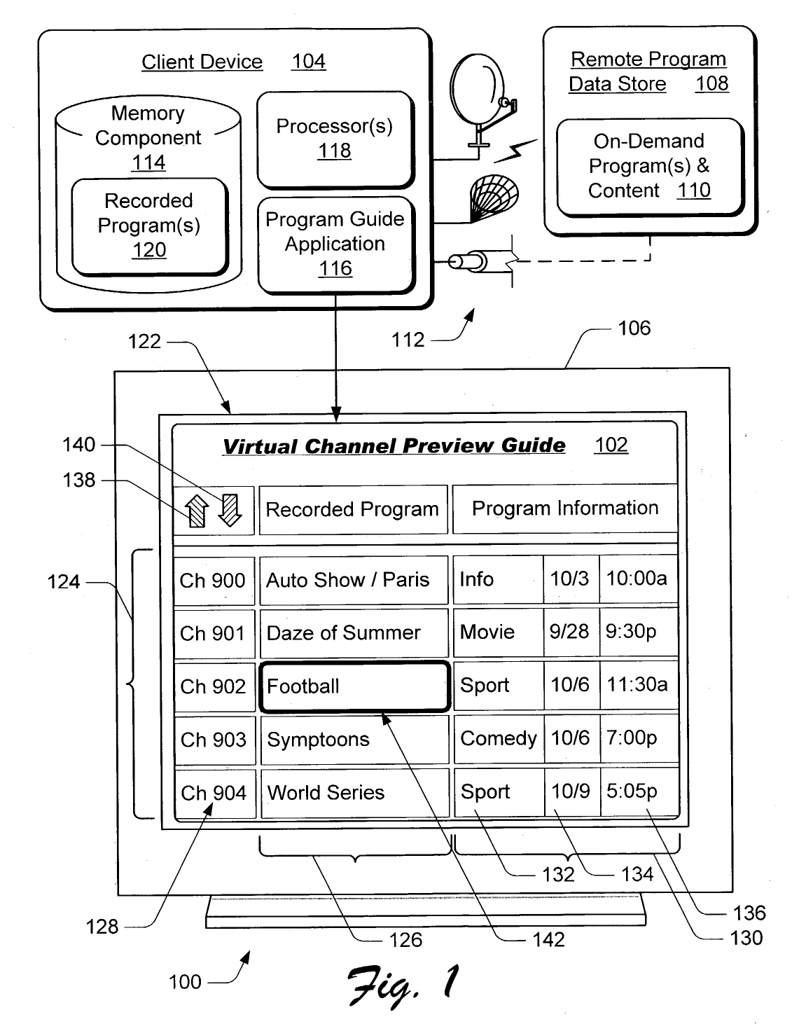

FIG. 1 illustrates various components of an exemplary virtual channel preview guide system 100 to implement a virtual channel preview guide 102. System 100 includes a client device 104, a display device 106, and a remote program data store 108 (e.g., memory component(s) not integrated with client device 104). The remote program data store 108 maintains on-demand programs and/or content 110, such as video on-demand movies. The on-demand programs and/or content 110 can include any programs and content that is accessible by the client device 104, such as via a point-to-point network. Client device 104 receives broadcast program content and/or the on-demand program(s) and content 110 via various transmission media 112, such as satellite transmission, radio frequency transmission, cable transmission, and/or via any number of other transmission media.

Client device 104 can receive the broadcast program content and/or the on-demand programs and content from a headend in a television-based content distribution system, for example, that provides the broadcast and on-demand programs as well as program guide data to multiple client devices. Client device 104 can be implemented in any number of embodiments, such as a set-top box, a digital video recorder (DVR) and playback system, and as any other type of client device that may be implemented in a television-based entertainment and information system.

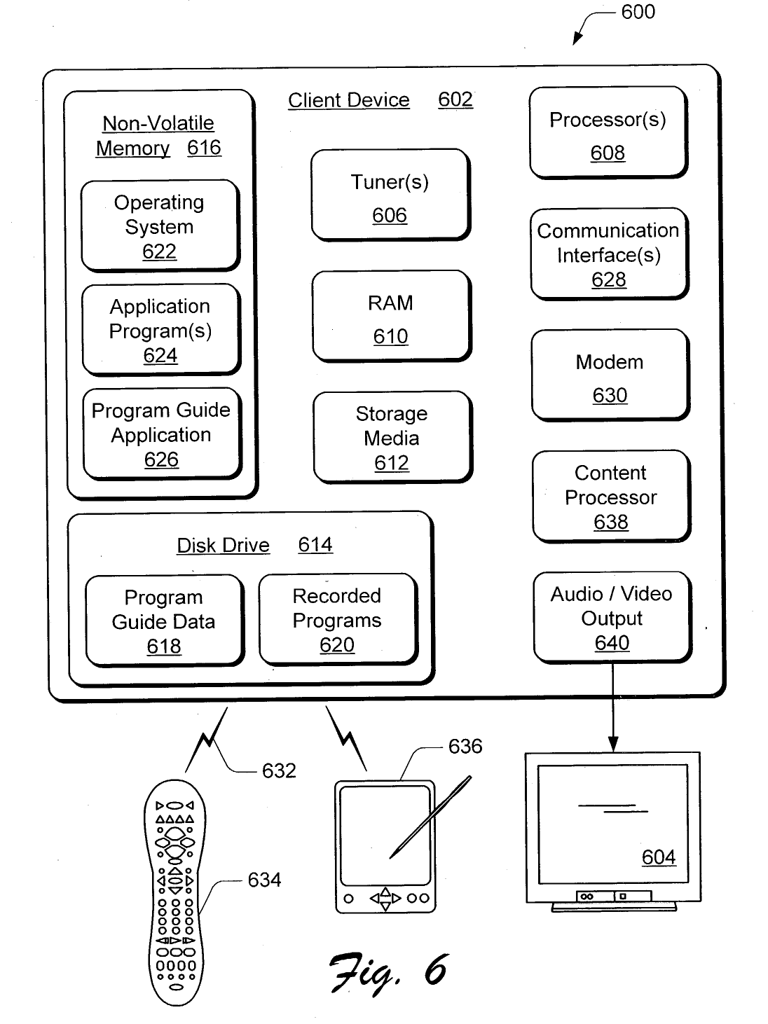

In this example, client device 104 includes a memory component 114, a program guide application 116, and one or more processors 118 (e.g., any of microprocessors, controllers, and the like) which process various instructions to control the operation of client device 104 and to communicate with other electronic and computing devices. Although not shown in this example, client device 104 may be implemented with any number and combination of differing components as further described below with reference to FIG. 6. Client device 104 receives programs as broadcast content and records the programs to be maintained with memory component 114 as recorded programs 120. Client device 104 can also receive the video on-demand program(s) and content 110 and record the programs to be maintained with memory component 114. Memory component 114 can be implemented as a disk drive, such as in a digital video recorder, for example.

As used herein, “programs” include news shows, sitcoms, comedies, movies, commercials, talk shows, sporting events, on-demand videos, and any other form of television-based entertainment and information. Further, “recorded programs” include any of the aforementioned “programs” that have been recorded and that are maintained with a memory component (e.g., memory component 114 in client device 104) as recorded programs 120, or that are maintained with a remote program data store (e.g., remote program data store 108) as on-demand programs and content 110. The “recorded programs” can also include any of the aforementioned “programs” that have been recorded and that are maintained at a broadcast center and/or at a headend that distributes the recorded programs to subscriber sites and client devices.

Program guide application 116 executes on processor(s) 118 and can be stored as computer-executable instructions in non-volatile memory (not shown),of client device 104. Program guide application 116 is implemented to generate the virtual channel preview guide 102 for display in a display region 122 of display device 106. Although program guide application 116 is illustrated and described as a single application configured to generate the virtual channel preview guide 102, program guide application 116 can be implemented as several component applications distributed to each perform one or more functions in a digital video recorder system and/or in any other client device in a television-based entertainment and information system.

Virtual channel preview guide 102 enables a viewer to navigate a program grid 124 and initiate a preview display of a recorded program (e.g., as used herein to reference an on-demand program or content 110 and/or a recorded program 120). The virtual channel preview guide 102 includes recorded program identifiers 126, associated virtual channel identifiers 128, and additional information 130 about respective recorded programs. Program guide application 116 also assigns, or otherwise associates, a different virtual channel (e.g., channels 900 through 1000 in this example) with each recorded program. Program guide application 116 can also determine the recorded program identifiers 126 from program data associated with the recorded programs. In this example, a recorded program identifier 126 is a program name, and an associated virtual channel identifier 128 is a virtual channel number.

The program guide application 116 can extract the recorded program identifiers 126 (e.g., the program names) and other associated program information 130 from program guide data that is received from a headend program data provider, for example. The program guide data can be embedded with received program content, or can be received as a separate broadcast. Similarly, the program guide application 116 can extract the program names 126 and other associated program information 130 for the on-demand programs and content 110 from the programs and content itself. The program names 126 and the other associated program information 130 can be received as embedded program content within the programs and associated content.

The additional information 130 about each respective recorded program can include a recorded program descriptor 132, a calendar date 134, and a time designator 136. Although only these three examples of additional recorded program information 130 are shown in this example, any combination and different types of additional information can be included in a virtual channel preview guide to further inform a viewer about the recorded programs. The recorded program descriptors 132 in this example are a program category that describes the genre of a recorded program and categorizes it as a particular program type. For example, a recorded program can be categorized as a movie, a comedy, a sporting event, a news program, a sitcom, a talk show, an informational program, or as any number of other category descriptions.

The calendar date 134 and time designator 136 corresponding to a recorded program identifies when the program was recorded, on which day and at what time, respectively. Although a calendar date 134 is shown to include only the month and a day of the month that a program was recorded, the calendar dates can also include a year designation (e.g., /02).

The on-demand programs and content 110 and the recorded programs 120 can be displayed in the virtual channel preview guide 102 in alphabetical order or in any other order (optionally user-selectable), such as by the program category 132, program recording date 134, and the like. In this example, the recorded program names 126 are listed in alphabetical order. Further, the recorded programs can be listed in the virtual channel preview guide 102 on a first-in, first-out basis such that each program consecutively recorded is associated with the next consecutive virtual channel number. When a recorded program 120 is deleted from memory component 114, or when a video on-demand program 110 is no longer available, program guide application 116 can update the virtual channel preview guide 102 to reflect that the recorded program has been deleted.

The recorded program names 126, virtual channel numbers 128, and associated information 130 about the on-demand programs and content 110 and recorded programs 120 are displayed and navigated in the virtual channel preview guide 102 as if the recorded programs were received via broadcast channels. Each recorded program corresponds to a virtual channel that may be “tuned” to render a preview display of the recorded program.

Virtual channel preview guide 102 includes a selectable control 138 that, when selected, scrolls the program grid 124 up to view recorded programs and information associated with virtual channel identifiers 128 lower than channel number nine-hundred (900). Similarly, a selectable control 140, when selected, scrolls the program grid 124 down to view recorded programs and information associated with virtual channel identifiers higher than channel number nine-hundred-four (904). Although the virtual channel identifiers 128 are shown as virtual channel numbers nine-hundred (900) through nine-hundred-four (904), any number of virtual channels can be assigned that each correspond to a video on-demand program 110 and/or recorded program 120.

Virtual channel preview guide 102 also includes a selectable control 1.42 shown implemented as an on-screen focus that can be positioned to identify a recorded program 126 and, when selected, client device 104 initiates a preview display of the associated video on-demand program 110 or recorded program 120. For example, selectable control 142 is positioned to identify a recorded “Football” sporting event. A channel change selection will initiate a preview display of the sporting event program on display device 106 for viewing. A viewer can move selectable control 142 within program grid 124 and generate a channel change selection by manipulating an input device, such as a remote control for example.

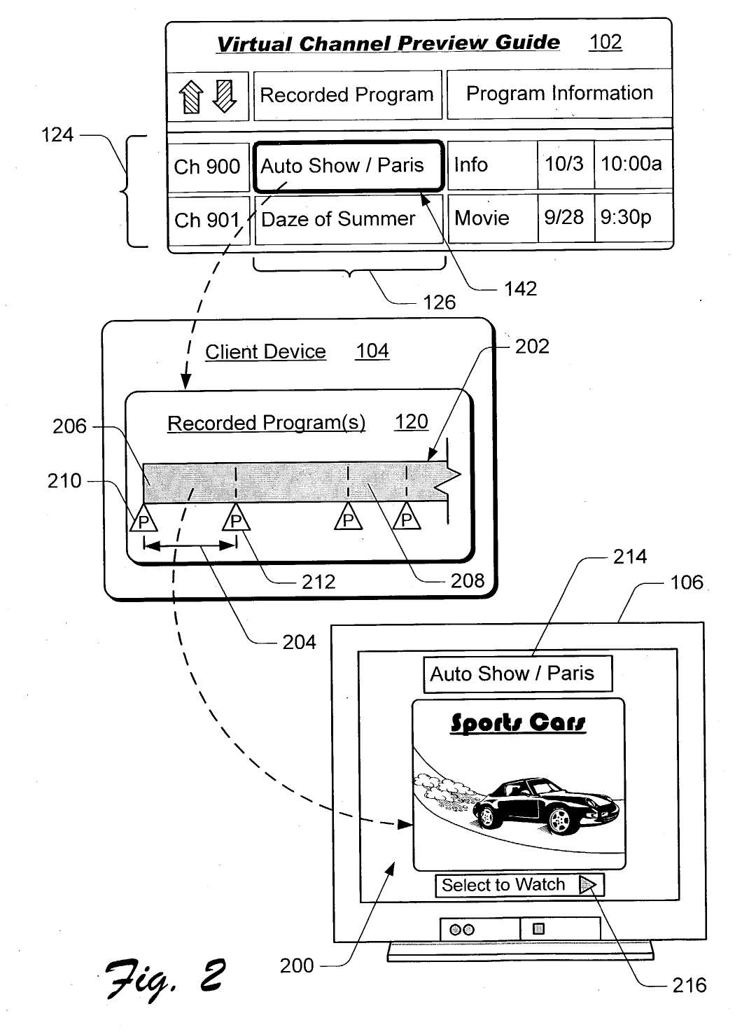

FIG. 2 illustrates an example of a program preview display 200 initiated with a virtual channel selection from the virtual channel preview guide 102. In the program grid 124 of virtual channel preview guide 102, the selectable control 142 is positioned to identify a recorded program 126 labeled “Auto Show/Paris”. When a selectable control associated with the recorded program is selected, such as the recorded program identifier “Auto Show/Paris” or the associated virtual channel identifier “Ch 900”, processor(s) 118 (FIG. 1) in client device 104 initiate preview display 200 of the recorded program on display device 106.

At client device 104, a recorded program 120 corresponding to the recorded program identifier 126 is maintained as digital program content 202. Preview display 200 can be initiated as a duration 204, such as a time duration or as any other measure of the digital program content 202. Further, preview display 200 can correspond to a beginning section 206 of the recorded program, to a designated section 208 of the recorded program, and/or to any number of sections of the recorded program (e.g., the digital program content 202). The digital program content 202 is designated with preview markers, such as preview marker 210 that designates the beginning of preview display 200 and a preview marker 212 that designates an end of the preview display. The preview markers can be implemented as metatags that are placed in the digital program content and interpreted by the client device to indicate the beginning and end of a preview.

The preview display 200 can include other associated recorded program information, such as a program identifier 214. Further, the preview display 200 includes a selectable control 216 that, when selected, initiates client device 104 rendering the recorded program 120 for viewing on display device 106.

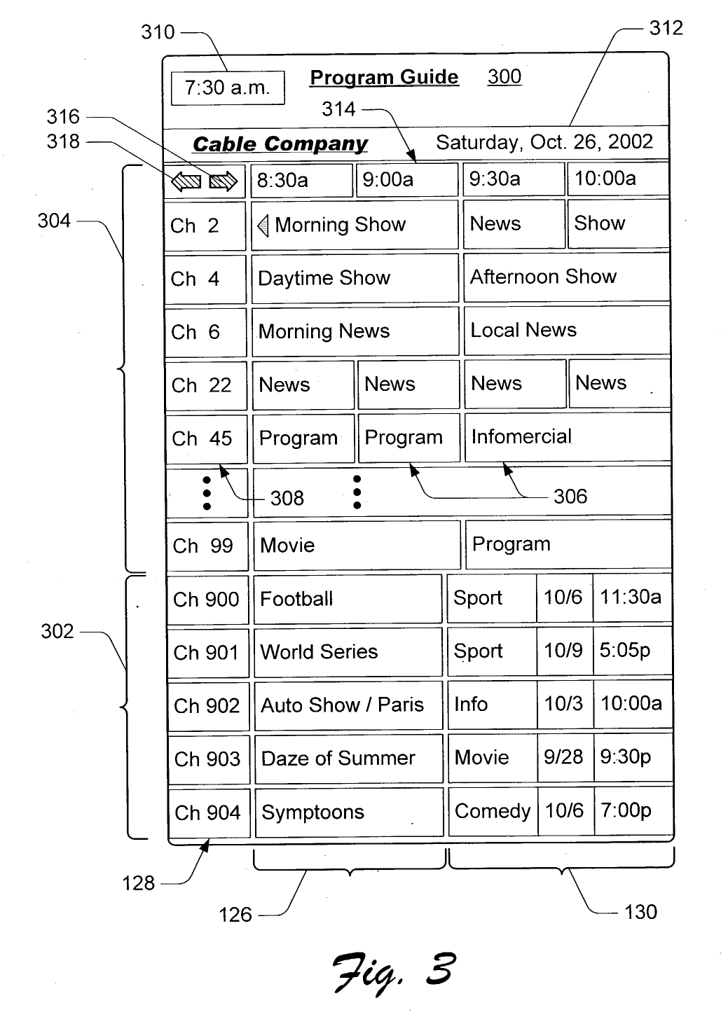

FIG. 3 illustrates an example of a program guide 300 that includes the exemplary virtual channel preview guide 102 shown in FIG. 1. Program guide 300 includes a program grid section 302 which displays the recorded program identifiers 126, the associated virtual channel identifiers 128, and the additional information 130 about respective recorded programs that are shown in the virtual channel preview guide 102. Program guide 300 also includes a program grid section 304 which displays schedule information to indicate when a particular program will be broadcast for viewing and on which channel the program will be broadcast. The broadcast program schedule information includes broadcast program names 306 and associated broadcast program channel numbers 308 corresponding to the programs that are scheduled to be broadcast.

In this example, program guide 300 also includes a current time display 310, a current date display 312, and broadcast program time displays 314 that indicate a time of day when a program will be broadcast for viewing. A particular broadcast program channel number 308 corresponds to a broadcast program time display 314 to indicate a program channel over which a program will be broadcast for viewing. For example, a “Local News” program will be broadcast for viewing at 9:30 a.m. on program channel six (6).

Program guide 300 includes a selectable control 316 that, when selected, scrolls the program grid section 304 ahead in time and/or ahead in days to provide a viewer with schedule information about future program broadcasts. Similarly, a selectable control 318, when selected, scrolls the program grid section 304 back in time and/or back in days to display previous programs and schedule information. Program guide 300 can also include a selectable control implemented as an on-screen focus, such as selectable control 142 (FIG. 1) described with reference to the virtual channel preview guide 102. An on-screen focus can be positioned to identify, or otherwise hi-lite, a broadcast program 306 and, when selected, initiate client device 104 tuning to the associated broadcast channel to render the broadcast program for display.

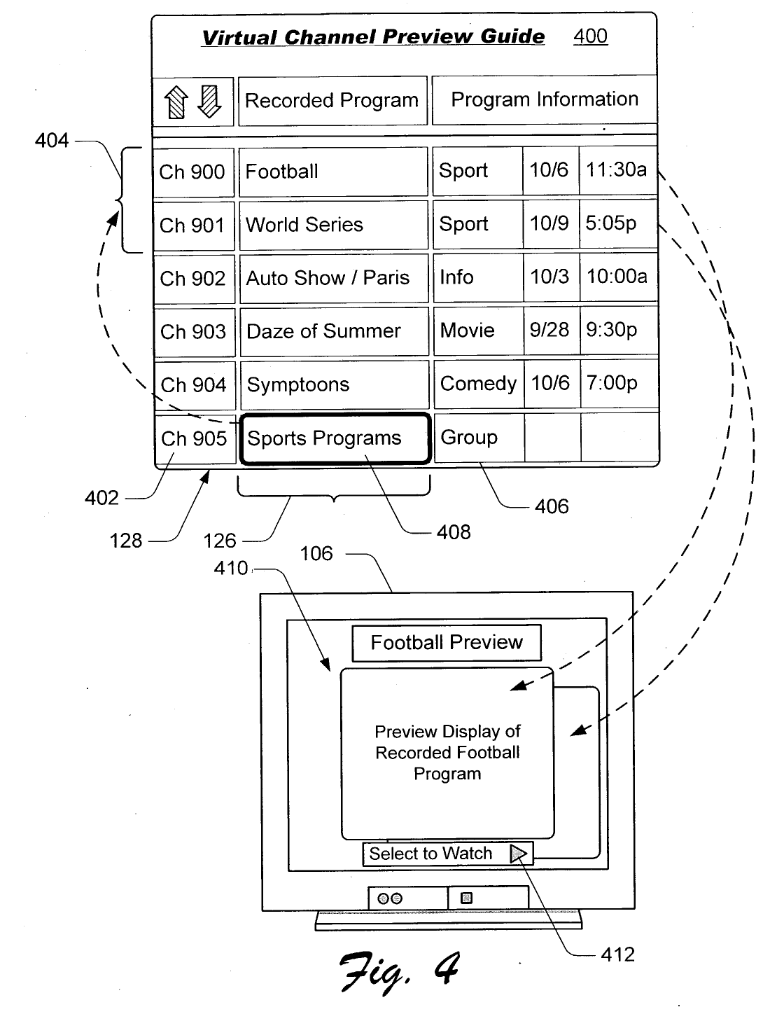

FIG. 4 illustrates an exemplary section of a virtual channel preview guide 400 that includes a virtual channel 402 (identified as “Ch 905”) which corresponds to a group 404 of recorded programs. The group 404 of recorded sports programs includes the recorded “Football” program and the recorded “World Series” program identified by virtual channels “Ch 900” and “Ch 901”, respectively. Virtual channel 402 is identified as a recorded programs group with a group identifier 406.

When virtual channel 402 or the program group identifier 126 is selected, such as with a selectable control 408, a preview display 410 of each recorded program corresponding to the group 404 is initiated for display on display device 106. The preview display 410 can be initiated to display a preview of each recorded program sequentially, as shown, or the preview display 410 can be initiated to show several previews of recorded programs on display device 106 at the same time. The preview display 410 includes a selectable control 412 that, when selected, initiates client device 104 (FIG. 1) discontinuing the preview display 410 and begin rendering the selected recorded program for viewing on display device 106.

Methods for a virtual channel preview guide may be described in the general context of computer-executable instructions. Generally, computer-executable instructions include routines, programs, objects, components, data structures, procedures, and the like that perform particular functions or implement particular abstract data types. The described methods may also be practiced in distributed computing environments where functions are performed by remote processing devices that are linked through a communications network. In a distributed computing environment, computer-executable instructions may be located in both local and remote computer storage media, including memory storage devices.

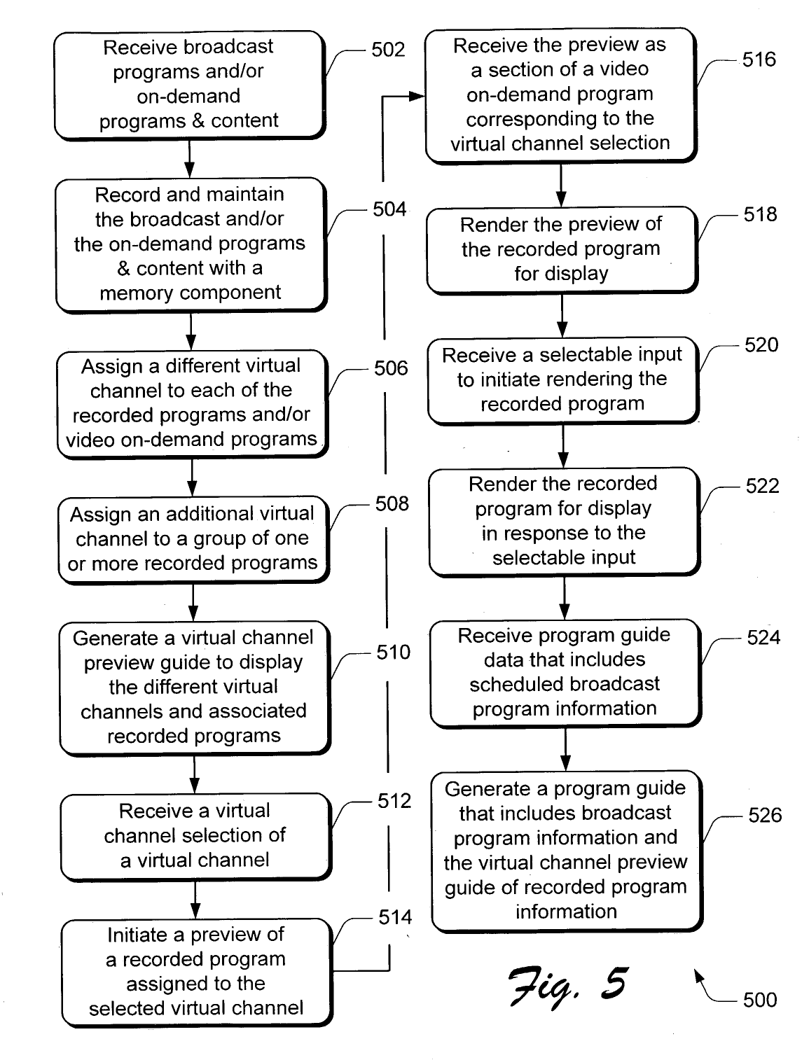

FIG. 5 illustrates a method 500 for a virtual channel preview guide of recorded broadcast and on-demand programs and content. The order in which the method is described is not intended to be construed as a limitation, and any number of the described method blocks can be combined in any order to implement the method. Furthermore, the method can be implemented in any suitable hardware, software, firmware, or combination thereof.

At block 502, broadcast and/or on-demand programs and content are received. The programs can be received as broadcast programs, on-demand programs or content, video on-demand programs and/or as any combination thereof. At block 504, the broadcast and/or on-demand programs and content are ii recorded and maintained as recorded programs with a local memory component. For example, client device 104 (FIG. 1) includes a memory component 114 to record and maintain recorded programs 120 that have been received as broadcast programs (or as on-demand programs 110 that are received and recorded).

At block 506, a different virtual channel is assigned to each of the one or more recorded programs. The recorded programs being assigned a different virtual channel can include, for example, the recorded programs 120 maintained locally at client device 104 with memory component 114, the on-demand programs and content 110 maintained by a remote program data store 108, and/or a combination of recorded broadcast and on-demand programs. For example, the program guide application 116 (FIG. 1) can assign virtual channels 128 (e.g., channel numbers 900 to 904 in this example) to the recorded programs 126. At block 508, an additional virtual channel is assigned to a group of one or more recorded programs. For example, virtual channel 402 (FIG. 4) is assigned to a group 404 of recorded programs that are identified as recorded sports programs.

At block 510, a virtual channel preview guide is generated to display the different virtual channels and the associated recorded programs. For example, virtual channel preview guide 102 (FIG. 1) is generated by program guide application 116 to display the virtual channels 128 and the associated recorded program identifiers 126 which correspond to the on-demand programs and content 110 and/or the recorded programs 120. The recorded programs 120 are maintained with the local (e.g., integrated with client device 104) memory component 114 and can include recorded broadcast programs and recorded on-demand programs. The recorded programs also include the on-demand programs and content 110 that are maintained with a remote program data store 108, or at an on-demand program provider. The virtual channel preview guide (e.g., preview guide 400) can also be generated to display the virtual channel 402 assigned to the group 404 of recorded programs. The virtual channel preview guide can be generated to display the recorded programs in alphabetical order and/or in a user-selectable order. Further, the virtual channel preview guide can be generated to display, for each of the recorded programs, a program name, an associated virtual channel number, and a date when a broadcast program was recorded, a time when a broadcast program was recorded, and a recorded program descriptor.

At block 512, a virtual channel selection of a virtual channel is received. For example, client device 104 (FIG. 1) can receive a user input as a virtual channel selection of a virtual channel identifier 128 or a recorded program identifier 126. Additionally, the virtual channel selection can be a virtual channel that corresponds to a group of recorded programs. For example, client device 104 can receive a user input as a virtual channel selection of virtual channel 402 (FIG. 4) that corresponds to a group 404 of recorded programs.

At block 514, a preview of a recorded program assigned to the selected virtual channel is initiated. For example, client device 104 initiates a preview display 200 of a recorded program 120 that is assigned, or otherwise associated, with a selected virtual channel 126. Additionally, in an event that a virtual channel selection corresponds to a group of recorded programs, client device 104 can initiate a preview display 410 of the recorded programs in the group 404 of recorded programs.

At block 516, the preview is received as a section of a video on-demand program corresponding to the virtual channel selection. For example, in an event that a virtual channel selection corresponds to an on-demand program 110 stored with a remote program data store 108, client device 104 receives the preview 200 as a section of the selected on-demand program.

At block 518, the preview of the recorded program is rendered for display. Rendering the preview can include rendering the preview as a section of a video on-demand program, as a duration 204 (FIG. 2) of the recorded program 120 corresponding to a beginning 206 of the recorded program, as a section 206 or 208 of the recorded program 120 that is designated with a preview marker 210 and/or 212, and/or as one or more sections 206 and 208 of the recorded program 120 where the one or more sections are designated with one or more preview markers.

At block 520, a selectable input is received to initiate rendering the recorded program. For example, client device 104 (FIG. 1) can receive a user input of selectable control 216 (FIG. 2) or selectable control 412 (FIG. 4) to initiate rendering the associated recorded program(s) for display. At block 522, the recorded program is rendered for display in response to the selectable input. The recorded program can be rendered as an on-demand program 110, as a recorded broadcast program 120, or as a recorded on-demand program maintained by client device 104 with local memory component 114.

At block 524, program guide data is received that includes broadcast program information for programs that are scheduled to be broadcast. For example, client device 104 receives broadcast program identifiers and associated program channel identifiers for programs that are scheduled to be broadcast.

At block 526, a program guide is generated that includes the broadcast program information and the virtual channel preview guide that includes the recorded program information. A program guide can be generated to include a broadcast program identifier and an associated program channel identifier for programs scheduled to be broadcast, and to include a virtual channel preview guide that displays a recorded program identifier and an associated virtual channel identifier for each of the recorded programs. For example, program guide application 116 is implemented to generate program guide 300 (FIG. 3) to display a virtual channel preview guide that includes the recorded program information shown in program grid section 302, and to display a broadcast program name 306 and an associated program channel number 308 in program grid section 304 for each of programs scheduled to be broadcast.

FIG. 6 illustrates a television-based system 600 that includes an exemplary client device 602 which includes components to implement a virtual channel preview guide, such as the exemplary processing system 100 (FIG. 1). System 600 also includes a display device 604 to display the virtual channel preview guide 102 (FIG. 1) and the program guide 300 (FIG. 3). Client device 602 can be implemented as a set-top box, a satellite receiver, a TV recorder with a hard disk, a digital video recorder (DVR) and playback system, a game console, an information appliance, and as any number of similar embodiments.

Client device 602 includes one or more tuners 606 which are representative of one or more in-band tuners that tune to various frequencies or channels to receive television signals, as well as an out-of-band tuner that tunes to the broadcast channel over which program data is broadcast to client device 602. Client device 602 also includes one or more processors 608 (e.g., any of microprocessors, controllers, and the like) which process various instructions to control the operation of client device 602 and to communicate with other electronic and computing devices.

Client device 602 can be implemented with one or more memory components, examples of which include a random access memory (RAM) 610, mass storage media 612, a disk drive 614, and a non-volatile memory 616 (e.g., ROM, Flash, EPROM, EEPROM, etc.). Disk drive 614 can include any type of magnetic or optical storage device, such as a hard disk drive, a magnetic tape,-a rewriteable compact disc, a DVD, and the like. The one or more memory components store various information and/or data such as received content, program guide data 618, recorded programs 620, configuration information for client device 602, and/or graphical user interface information. Alternative implementations of client device 602 can include a range of processing and memory capabilities, and may include any number of differing memory components than those illustrated in FIG. 6. For example, full-resource clients can be implemented with substantial memory and processing resources, whereas low-resource clients may have limited processing and memory capabilities.

An operating system 622 and one or more application programs 624 can be stored in non-volatile memory 616 and executed on processor(s) 608 to provide a runtime environment. A runtime environment facilitates extensibility of client device 602 by allowing various interfaces to be defined that, in turn, allow application programs 624 to interact with client device 602. The application programs 624 can include a browser to browse the Web (e.g., “World Wide Web”), an email program to facilitate electronic mail, and any number of other application programs.

A program guide application 626 that executes on processor(s) 608 is also stored in non-volatile memory 616 and is implemented to process the program guide data 618 and generate virtual channel preview guide 102 (FIG. 1) and program guide 300 (FIG. 3) for display. Program guide application 626 generates the program guides which enable a viewer to navigate through an onscreen display and locate broadcast programs, recorded programs, video on-demand programs and movies, interactive game selections, and other media access information or content of interest to the viewer. With program guide application 626, the television viewer can look at schedules of current and future programming, set reminders for upcoming programs, and/or enter instructions to record one or more programs.

Client device 602 further includes one or more communication interfaces 628 and a PSTN, DSL, cable, or other type of modem 630. A communication interface 628 can be implemented as a serial and/or parallel interface, as a wireless interface, and/or as any other type of network interface. A wireless interface enables client device 602 to receive control input commands 632 and other information from a user-operated input device, such as from a remote control device 634 or from another infrared (IR), 802.11, Bluetooth, or similar R-F input device. Input devices can include a wireless keyboard or another handheld input device 636 such as a personal digital assistant (PDA), handheld computer, wireless phone, or the like. A network interface and a serial and/or parallel interface enables client device 602 to interact and communicate with other electronic and computing devices via various communication links. Modem 630 facilitates client device 602 communication with other electronic and computing devices via a conventional telephone line, a DSL connection, cable, and/or other type of connection.

Client device 602 also includes a content processor 638 which can include a video decoder and/or additional processors to receive, process, and decode broadcast video signals and program data, such as NTSC, PAL, SECAM, or other television system analog video signals, as well as DVB, ATSC, or other television system digital video signals. For example, content processor 638 can include an MPEG-2 or MPEG-4 (Moving Pictures Experts Group) decoder that decodes MPEG-encoded video content and/or image data. The systems described herein can be implemented for any type of video encoding format as well as for data and/or content streams that are not encoded.

Typically, video content and program data includes video data and corresponding audio data. Content processor 638 generates video and/or display content that is formatted for display on display device 604, and generates decoded audio data that is formatted for presentation by a presentation device, such as one or more speakers (not shown) in display device 604. Content processor 638 can include a display controller (not shown) that processes the video and/or display content to display corresponding images on display device 604. A display controller can include a graphics processor, microcontroller, integrated circuit, and/or similar video processing component to process the images.

Client device 602 also includes an audio and/or video output 640 that provides the audio, video, and/or display signals to television 604 or to other devices that process and/or display, or otherwise render, the audio and video data. Video signals and audio signals can be communicated from client device 602 to television 604 via an RF (radio frequency) link, S-video link, composite video link, component video link, or other similar communication link.

Although shown separately, some of the components of client device 602 may be implemented in an application specific integrated circuit (ASIC). Additionally, a system bus (not shown) typically connects the various components within client device 602. A system bus can be implemented as one or more of any of several types of bus structures, including a memory bus or memory controller, a peripheral bus, an accelerated graphics port, or a local bus using any of a variety 15 of bus architectures. By way of example, such architectures can include an Industry-Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

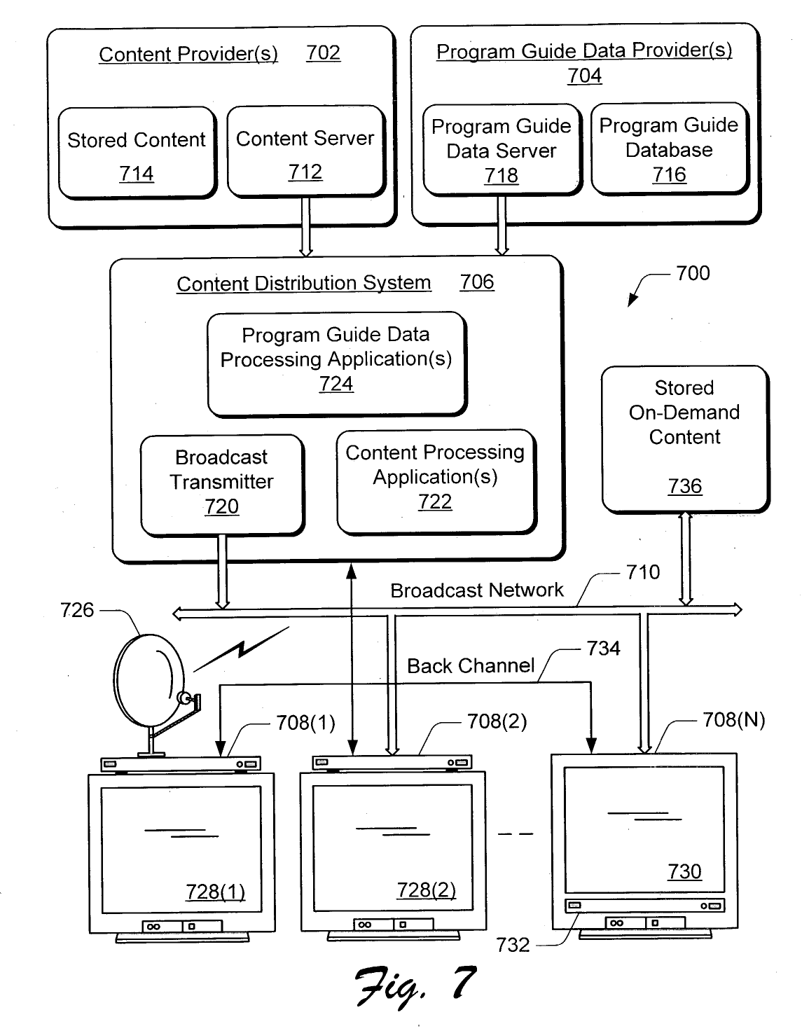

FIG. 7 illustrates an exemplary system architecture 700 in which a virtual channel preview guide can be implemented. System 700 facilitates distribution of content and program guide data to multiple viewers. The system 700 includes one or more content providers 702, one or more program guide data providers 704, a content distribution system 706, and multiple client devices 708(1), 708(2), . . . , 708(N) coupled to the content distribution system 706 via a broadcast network 710.

A content provider 702 can be implemented as a satellite operator, a network television operator, a cable operator, and the like. A content provider 702 includes a content server 712 to control distribution of stored content 714, such as movies, television programs, commercials, music, and similar audio, video, and/or image content from content provider 702 to the content distribution system 706. Additionally, content server 712 controls distribution of live content (e.g., content that was not previously stored, such as live feeds) and/or content stored at other locations to the content distribution system 706.

A program guide data provider 704 includes a program guide database 716 and a program guide data server 718. The program guide database 716 stores electronic files of program guide data which is used to generate an electronic or interactive program guide (or, “program guide”). Program guide data can include a program title, program broadcast day(s) to identify which days of the week the program will be broadcast, program start times(s) to identify a time that the program will be broadcast on the particular day or days of the week, and a program category. A program category describes the genre of a program and categorizes it as a particular program type. For example, a program can be categorized as a movie, a comedy, a sporting event, a news program, a sitcom, a talk show, or as any number of other category descriptions. Program guide data can also include program ratings, characters, descriptions, actor names, station identifiers, channel identifiers, other schedule information, and so on. Additionally, program guide data may include video on-demand content information, such as movie schedules, as well as application information, such as for interactive games, and other programming information that may be of interest to a viewer.

The program guide data server 718 processes the program guide data prior to distribution to generate a published version of the program guide data which can contain programming information for all broadcast channels and on-demand content listings for one or more days. The processing may involve any number of techniques to reduce, modify, or enhance the program data such as data compression, format modification, and the like. The program guide data server 718 controls distribution of the published version of the program guide data from a program guide data provider 704 to the content distribution system 706 using, for example, a file transfer protocol (FTP) over a TCP/IP network (e.g., Internet or Intranet). Further, the published version of the program guide data can be transmitted from program data provider 704 via a satellite and the content distribution system 706 directly to a client device 708.

Content distribution system 706 is representative of a headend service and/or program data center that provides program guide data, as well as content; to multiple subscribers (e.g., client devices 708). Each content distribution system 706 may receive a different version of the program guide data that takes into account different programming preferences and lineups. The program guide data server 718 can create different versions of the program guide data that includes those channels of relevance to respective headend services, and the content distribution system 706 transmits the program guide data to the multiple client devices 708. In one implementation, for example, content distribution system 706 utilizes a carousel file system to repeatedly broadcast the program guide data over an out-of-band (OOB) channel to the client devices 708. Alternatively, the multiple client devices 708 can receive standard, or uniform, program guide data and individually determine which program guide data to display based on the associated headend service.

Content distribution system 706 includes a broadcast transmitter 720, one or more content processing applications 722, and one or more program guide data processing applications 724. Broadcast transmitter 720 broadcasts signals, such as cable television signals, across broadcast network 710. Broadcast network 710 can include a cable television network, RF, microwave, satellite, and/or data network, such as the Internet, and may also include wired or wireless transmission media using any broadcast format or broadcast protocol. Additionally, broadcast network 710 can be any type of network, using any type of network topology and any network communication protocol, and can be represented or otherwise implemented as a combination of two or more networks.

A content processing application 722 processes the content received from a content provider 702 prior to transmitting the content across broadcast network 710. Similarly, a program guide data processing application 724 processes the program guide data received from a program guide data provider 704 prior to transmitting the program guide data across broadcast network 710. A particular content processing application 722 may encode, or otherwise process, the received content into a format that is understood by the multiple client devices 708 which are coupled to broadcast network 710. Although FIG. 7 shows a single content provider 702, a single program guide data provider 704, and a single content distribution system 706, exemplary system 700 can include any number of content providers and/or program guide data providers coupled to any number of content distribution systems.

Client devices 708 can be implemented in a number of ways. For example, a client device 708(1) receives broadcast content from a satellite-based transmitter via a satellite dish 726. Client device 708(1) is also referred to as a set-top box or a satellite receiving device. Client device 708(1) is coupled to a television 728(1) for presenting the content received by the client device (e.g., audio data, video data, and image data), as well as a graphical user interface. A particular client device 708 can be coupled to any number of televisions 728 and/or similar devices that can be implemented to display or otherwise render content. Similarly, any number of client devices 708 can be coupled to a single television 728.

Client device 708(2) is also coupled to receive broadcast content from It broadcast network 710 and provide the received content to associated television 728(2). Client device 708(N) is an example of a combination television 730 and integrated set-top box 732. In this example, the various components and functionality of the set-top box are integrated into the television, rather than using two separate devices. The set-top box integrated into the television can receive broadcast signals via a satellite dish (similar to satellite dish 726) and/or via broadcast network 710. In alternate implementations, client devices 708 may receive broadcast signals via the Internet or any other broadcast medium, such as back channel 734 which can be implemented as a Internet protocol (IP) connection or as other protocol connections using a modem connection and conventional telephone line, for example. Further, back channel 734 provides an alternate communication link between each of the client devices 708, and between the client devices 708 and the content distribution system 706.

The exemplary system 700 also includes stored on-demand content 736, such as video on-demand (VOD) movie content. The stored on-demand content 736 can be viewed with a television 728 via a client device 708 through an onscreen movie guide, for example, and a viewer can enter instructions to stream a particular movie, or other stored content, to a corresponding client device 708.

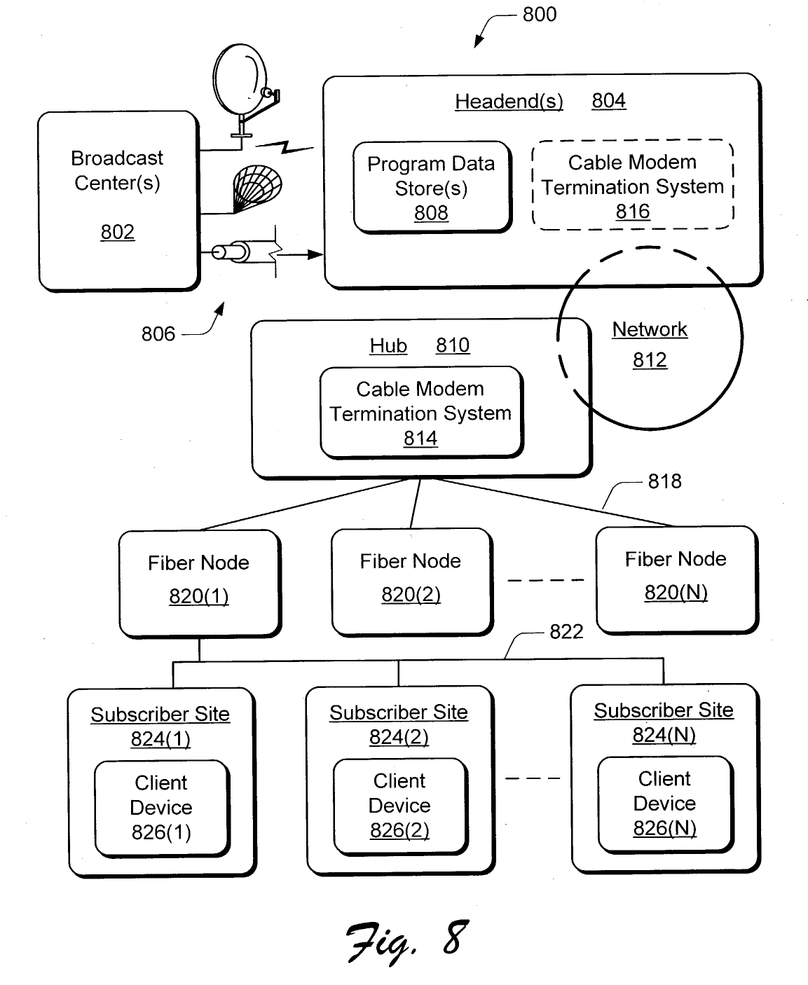

FIG. 8 illustrates an exemplary broadcast video distribution architecture 800 in which a virtual channel preview guide can be implemented. One or more broadcast centers 802 provide broadcast content to one or more headends 804 via one or more transmission media 806. Each broadcast center 802 and headend 804 interfaces with the various transmission media 806, such as a satellite transmission, radio frequency transmission, cable transmission, and/or via any number of other transmission media. A broadcast center 802 can be implemented as a satellite operator, a network television operator, a cable operator, and the like.

A headend 804 includes one or more program data stores 808 to record the broadcast content that is received via a transmission media 806. The broadcast content can be stored, or otherwise recorded, while the broadcast content is in a compressed format, for example, in order to facilitate the ongoing storage of the content over days, weeks, or even indefinitely. The compression format may comport with a Moving Pictures Expert Group (MPEG) algorithm, such as MPEG-2, MPEG-4, and so forth. Other compression technologies may alternatively be employed, such as Microsoft Windows® Media, Advanced Simple Profile (ASP), Cintak, and the like.

A headend 804 and a hub 810 communicate across a network 812 which can be implemented as a fiber ring that may operate with a packet-based protocol, such as Internet protocol (IP), IP over asynchronous transfer mode (ATM), and other protocols. Packets can therefore be communicated between headend 804 and hub 810 which includes a cable modem termination system 814 for terminating communications from downstream cable modems. Alternatively, headend 804 may include a cable modem termination system 816 to terminate the cable modem communications. Although only one hub 810 is illustrated in architecture 800, a headend 804 can distribute broadcast content to multiple hubs 810 via network 812.

Hub 810 distributes the broadcast content over fiber lines 818 to one or more fiber nodes 820(1), 820(2) . . . 820(N). Each fiber node 820 has one or more coaxial lines 822 over which the broadcast content is output, and each coaxial line 822 includes coaxial line drops to multiple subscriber sites 824(1), 824(2), . . . 824(N). Each subscriber site 824 includes one or more client devices 826(1), 826(2), . . . 826(N), respectively. Subscriber sites 824 can be homes, businesses, and the like with each subscriber site 824 including multiple client devices 826 that are each directly or indirectly interfacing with one or more of coaxial lines 822. Client devices 826 may be computers, set-top boxes of varying capabilities, hand-held and/or portable electronic devices, digital televisions, and so forth. Each client device 826 may include an integrated video screen or may be coupled to a video screen.

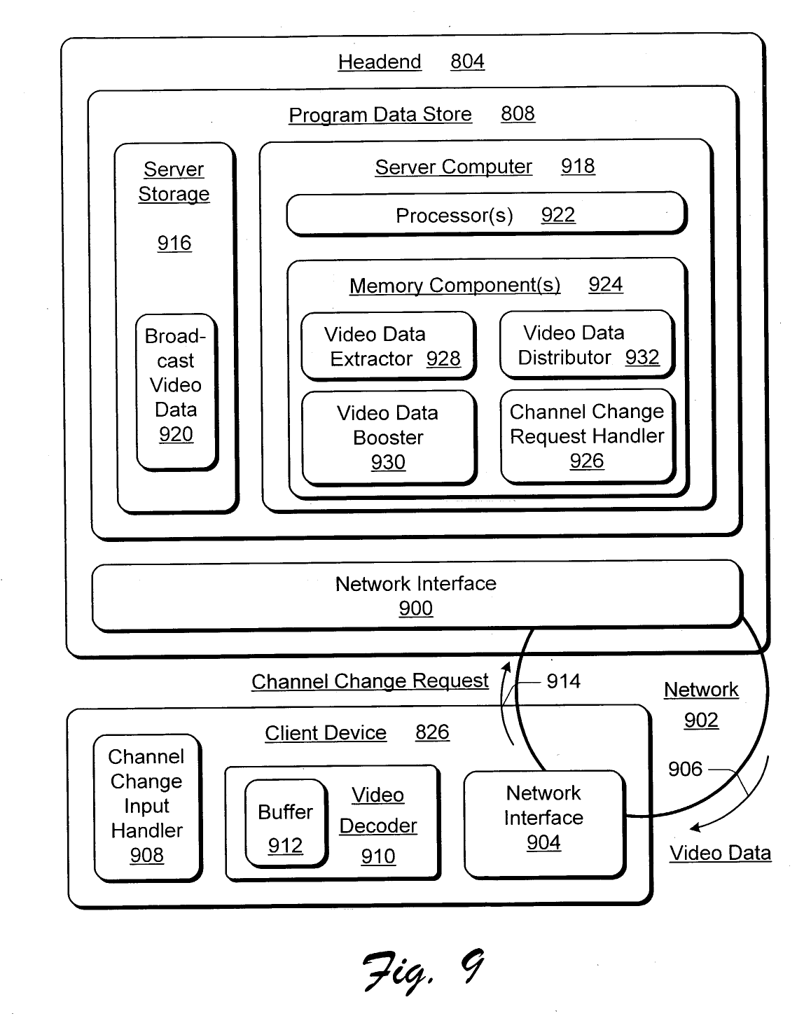

FIG. 9 further illustrates an exemplary headend 804 and an exemplary client device 826 as shown in FIG. 8. Headend 804 includes a network interface 900 to communicate over a network 902, and client device 826 includes a network interface 904 to communicate over the network 902. Network 902 can be any two-way unicast network, such as a unicast network that enables point-to-point Internet protocol (IP) sessions, for example. Alternatively, network 902 can be implemented as a video-on-demand (VOD) type network, as a video over digital subscriber line (DSL)-based network, and the like.

Network 902 may include one or more other nodes that are upstream of client device 826 in addition to headend 804. For example, hub 810 (FIG. 8) and fiber nodes 820 may be located between client device 826 and headend 804 for forwarding and/or routing packets or other communications between the devices. Additionally, network 902 can be implemented as a combination of networks and network interfaces 900 and 904 may vary depending on the architecture of network 902. In an exemplary cable network implementation, network interface 900 includes a cable modem termination system (such as system 816 in FIG. 8) if there is not an intervening cable modem termination system in network 902, and network interface 904 includes a cable modem. Network interface 900 and/or network interface 904 may also include components for interacting with an IP network, a DSL network, and so forth. These components may include a receiver, a transmitter, a transceiver, etc. that are adapted to interact with the appropriate network.

In one exemplary implementation, broadcast content distribution from headend 804 to client device 826 is implemented with a point-to-point IP session that is established between headend 804 and client device 826. Broadcast content, such as video data 908 for a specific channel, is streamed to client device 826 across network 902. Thus, each client device 826 receives its own designated broadcast video data stream according to its corresponding requested channel. Further, each fiber node 820 (FIG. 1), if present, has a different current allocation of a two-way portion of the network that is intended for downstream transmissions to client devices 826.

Client device 826 includes a channel change input handler 908 and a video decoder 910, as well as the network interface 904. Video decoder 910 includes a buffer 912 for storing received broadcast content, such as the video data, prior to decoding. Channel change input handler 908 receives channel change input requests from a user of client device 826. A channel change input request can be received from a remote control, a keyboard, a personal digital assistant (PDA), a touch-sensitive screen, integrated keys, and from any other type of input device.

Channel change input handler 908 can be implemented as executable instructions and/or hardware, software, firmware, or some combination thereof. Channel change input handler 908 constructs a channel change request 914 in packet form that includes an indicator of the requested channel. Channel change request 914 is communicated from channel change input handler 908 to network interface 904 of client device 826 for transmission over network 902.

Network interface 900 of headend 804 receives channel change request 914 via network 902, and provides the channel change request 914 to the program data store 808. Program data store 808 includes a server storage 918 and a server computer 918. Server storage 918 includes a storage device (not explicitly shown) that comprises mass memory storage, such as a disk-based storage device. Examples of suitable disk-based storage devices and/or systems include a redundant array of independent/inexpensive disks (RAID), a Fibre Channel storage device, and the like.

Server storage 918 stores broadcast video data 920 which is broadcast from a broadcast center 802 (FIG. 1) to headend 804 in a compressed format. In an exemplary implementation, the compressed format comprises a digital stream in accordance with an MPEG protocol, such as MPEG-4. However, other compression formats may alternatively be used. As the compressed digital stream is received at headend 804, it is stored as broadcast video data 920. Server storage 918 can maintain broadcast video data 920 for multiple channels as it is received over hours, days, weeks, and/or indefinitely.

Server computer 918 enables access to the stored, or otherwise recorded, broadcast video data 920 at server storage 918. Server computer 918 includes one or more processors 922 and one or more memory component(s) 924. Although not shown, server computer 918 may also include other components such as input/output interfaces; a local disk drive; hardware and/or software for encoding, decoding, and otherwise manipulating video data, and so forth. A memory component 924 can be implemented as, or include, a non-volatile memory such as disk drive(s) or flash memory and/or volatile memory such as random access I memory (RAM). In an exemplary implementation, a memory component 924 includes electronically-executable instructions.

Specifically, a memory component 924 includes the following electronically-executable instructions: a channel change request handler 928, a video data extractor 928, a video data booster 930, and a video data distributor 932. The electronically-executable instructions of memory component 924 can be executed on a processor 922 to implement functions as described below. In alternative implementations, one or more of channel change request handler 926, video data extractor 928, video data booster 930, and video data distributor 932 may be stored in a memory such that they are hardware encoded for automatic execution and/or for faster execution by a processor 922.

Network interface 900 forwards channel change request 914 to channel change request handler 926 which isolates the requested channel from channel change request 914 and provides the requested channel to video data extractor 928. Video data extractor.928 extracts broadcast video data for the requested channel from broadcast video data 920 of server storage 918. Video data distributor 932 communicates the broadcast video data to network interface 900 which transmits the broadcast video data over network 902 as video data packet(s) 908. Client device 826 receives the video data packet(s) 908 via network 902 at network interface 904.

Although the invention has been described in language specific to structural features and/or methods, it is to be understood that the invention defined in the appended claims is not necessarily limited to the specific features or methods described. Rather, the specific features and methods are disclosed as exemplary implementations of the claimed invention.

1. A client device, comprising:
an application program configured to associate a different virtual channel with each of one or more recorded programs, the application program further configured to generate a virtual channel preview guide to display the different virtual channels and the associated one or more recorded programs; and
a processor configured to receive a virtual channel selection of a virtual channel and initiate a preview of a recorded program associated with the virtual channel.

2. A client device as recited in claim 1, wherein the one or more recorded programs include at least one recorded broadcast program and at least one on-demand program.

3. A client device as recited in claim 1, wherein the one or more recorded programs include at least one of a recorded broadcast program and an on-demand program.

4. A client device as recited in claim 1, wherein the application program is further configured to generate the virtual channel preview guide to display the different virtual channels for each of one or more recorded broadcast programs and each of one or more on-demand programs.

5. A client device as recited in claim 1, wherein the application program is further configured to generate the virtual channel preview guide to display a different virtual channel for at least one of a recorded broadcast program and an on-demand program.

6. A client device as recited in claim 1, further comprising a memory component configured to maintain digital program content corresponding to at least one recorded broadcast program, and wherein the one or more recorded programs include the at least one recorded broadcast program and at least one on-demand program maintained with a remote program data store.

7. A client device as recited in claim 1, further comprising a memory component configured to maintain digital program content corresponding to at least one recorded broadcast program, and wherein the one or more recorded programs include the at least one recorded broadcast program and at least one on-demand program maintained by an on-demand program provider.

8. A client device as recited in claim 1, further comprising a memory component configured to record broadcast program content corresponding to the one or more recorded programs, and wherein the application program is further configured to generate the virtual channel preview guide to display the different virtual channels for each of the one or more recorded programs and each of one or more on-demand programs.

9. A client device as recited in claim 1, further comprising:
a tuner configured to receive broadcast program content corresponding to the one or more recorded programs, the tuner further configured to receive on-demand program content corresponding to the one or more recorded programs;
a memory component configured to record the broadcast program content; and
wherein the application program is further configured to generate the virtual channel preview guide to display the different virtual channels for each of the recorded broadcast programs and for each of the on-demand programs.

10. A client device as recited in claim 1, wherein the processor is further configured to receive an on-demand selection corresponding to the virtual channel and initiate receiving the recorded program associated with the virtual channel.

11. A client device as recited in claim 1, further comprising a memory component configured to maintain digital program content corresponding to the recorded program, and wherein the processor is further configured to receive an on-demand selection corresponding to the virtual channel and initiate receiving the recorded program.

12. A client device as recited in claim 1, further comprising:
a tuner configured to receive broadcast program content, and further configured to receive on-demand program content; and
a memory component configured to maintain the broadcast program content and the on-demand program content as the one or more recorded programs.

13. A client device as recited in claim 1, further comprising a program content processor configured to render the preview of the recorded program.

14. A client device as recited in claim 1, further comprising a program content processor configured to render the preview of the recorded program, and wherein the processor is further configured to receive a selectable input to initiate rendering the recorded program.

15. A client device as recited in claim 1, wherein the processor is further configured to initiate the preview as a duration of the recorded program that corresponds to a beginning of the recorded program.

16. A client device as recited in claim 1, wherein the processor is further configured to initiate the preview as a section of the recorded program, the section being designated with a preview marker.

17. A client device as recited in claim 1, wherein the processor is further configured to initiate the preview as one or more sections of the recorded program, each section being designated with one or more preview markers.

18. A client device as recited in claim 1, wherein the application program is further configured to list the one or more recorded programs in alphabetical order in the virtual channel preview guide.

19. A client device as recited in claim 1, wherein the application program is further configured to list the one or more recorded programs in a user-selectable order in the virtual channel preview guide.

20. A client device as recited in claim 1, wherein the application program is further configured to generate the virtual channel preview guide to display, for each of the one or more recorded programs, a program name, an associated virtual channel number, and at least one of a date when a recorded program was recorded, a time when the recorded program was recorded, and a program descriptor.

21. A digital video recorder comprising the client device as recited in claim 1.

22. A virtual channel preview guide, comprising:
one or more program identifiers that each correspond to a recorded program;
one or more virtual channel identifiers each associated with a different program identifier;
a selectable control configured to initiate a preview of a recorded program; and
a preview display configured to display the preview of the recorded program in an event that the selectable control is selected.

23. A virtual channel preview guide as recited in claim 22, wherein the one or more program identifiers correspond to at least one recorded broadcast program and at least one on-demand program.

24. A virtual channel preview guide as recited in claim 22, wherein the one or more program identifiers correspond to at least one of a recorded broadcast program and an on-demand program.

25. A virtual channel preview guide as recited in claim 22, wherein the one or more program identifiers correspond to at least one recorded broadcast program maintained with a local memory component and at least one on-demand program maintained with a remote program data store.

26. A virtual channel preview guide as recited in claim 22, wherein the selectable control is a virtual channel identifier corresponding to the recorded program.

27. A virtual channel preview guide as recited in claim 22, wherein the selectable control is a program identifier corresponding to the recorded program.

28. A virtual channel preview guide as recited in claim 22, wherein the preview display includes an additional selectable control configured to initiate rendering the recorded program in an event that the additional selectable control is initiated.

29. A virtual channel preview guide as recited in claim 22, wherein the selectable control is further configured to initiate the preview as a duration of the recorded program that corresponds to a beginning of the recorded program.

30. A virtual channel preview guide as recited in claim 22, wherein the selectable control is further configured to initiate the preview as a section of the recorded program, the section being designated with a preview marker.

31. A virtual channel preview guide as recited in claim 22, wherein the selectable control is further configured to initiate the preview as one or more sections of the recorded program, the one or more sections being designated with one or more preview markers.

32. A virtual channel preview guide as recited in claim 22, further comprising:
an additional virtual channel identifier associated with a group of recorded programs; and
an additional selectable control configured to initiate a preview of each of the group of recorded programs.

33. A virtual channel preview guide as recited in claim 22, wherein the one or more program identifiers are listed in alphabetical order.

34. A virtual channel preview guide as recited in claim 22, wherein the one or more program identifiers are listed in a user-selectable order.

35. A virtual channel preview guide as recited in claim 22, wherein the one or more program identifiers are each a program name of a recorded program, and wherein the one or more virtual channel identifiers are each a different virtual channel number associated with a different program name.

36. A virtual channel preview guide as recited in claim 22, wherein the one or more program identifiers are each a program name of a recorded program, and wherein the one or more virtual channel identifiers are each a different virtual channel number associated with a different program name.

37. A virtual channel preview guide as recited in claim 22, further comprising one or more calendar dates to each identify when a recorded program was recorded.

38. A virtual channel preview guide as recited in claim 22, further comprising one or more time designators to each identify when a recorded program was recorded.

39. A virtual channel preview guide as recited in claim 22, further comprising one or more recorded program descriptors that each identify a category of a recorded program.

40. A program guide, comprising:
a virtual channel preview guide as recited in claim 22;
one or more broadcast program identifiers each corresponding to a program scheduled for broadcast; and
one or more program channel identifiers each associated with a different broadcast program identifier in a display of the program guide.

41. A client device in a television-based system comprising the virtual channel preview guide as recited in claim 22.

42. A digital video recorder comprising the virtual channel preview guide as recited in claim 22.

43. A method, comprising:
assigning a different virtual channel to each of one or more recorded programs;
generating a virtual channel preview guide to display the different virtual channels and the one or more recorded programs;
receiving a virtual channel selection of a virtual channel; and
initiating a preview of a recorded program assigned to the virtual channel.

44. A method as recited in claim 43, wherein assigning includes assigning different virtual channels to each of one or more recorded broadcast programs and each of one or more on-demand programs.

45. A method as recited in claim 43, wherein assigning includes assigning a different virtual channel to at least one of a recorded broadcast program and an on-demand program.

46. A method as recited in claim 43, further comprising assigning an additional virtual channel to a group of the one or more recorded programs.

47. A method as recited in claim 43, further comprising assigning an additional virtual channel to a group of one or more recorded programs, and wherein generating includes generating the virtual channel preview guide to display the additional virtual channel and a group identifier of the group of one or more recorded programs.

48. A method as recited in claim 43, further comprising:
assigning an additional virtual channel to a group of one or more recorded programs;
generating the virtual channel preview guide to display the additional virtual channel and a group identifier of the group of one or more recorded programs;
receiving a virtual channel selection of the additional virtual channel; and
initiating a preview of each recorded program in the group of one or more recorded programs.

49. A method as recited in claim 43, further comprising receiving the one or more recorded programs which include at least one recorded broadcast program and at least one on-demand program.

50. A method as recited in claim 43, further comprising receiving the one or more recorded programs which include at least one of a recorded broadcast program and an on-demand program.

51. A method as recited in claim 43, further comprising:
receiving the one or more recorded programs which include at least one recorded broadcast program and at least one on-demand program;
maintaining the at least one recorded broadcast program with a local memory component; and
wherein generating includes generating the virtual channel preview guide to display the at least one recorded broadcast program and the at least one on-demand program maintained with a remote program data store.

52. A method as recited in claim 43, further comprising:
receiving the one or more recorded programs which include at least one recorded broadcast program and at least one on-demand program;
maintaining the at least one recorded broadcast program with a local memory component; and
wherein generating includes generating the virtual channel preview guide to display the at least one recorded broadcast program and the at least one on-demand program maintained by an on-demand program provider.

53. A method as recited in claim 43, further comprising receiving an on-demand program corresponding to the virtual channel selection.

54. A method as recited in claim 43, further comprising receiving the preview as a section of an on-demand program corresponding to the virtual channel selection.

55. A method as recited in claim 43, further comprising rendering the preview of the recorded program.

56. A method as recited in claim 43, further comprising:
receiving an on-demand program corresponding to the virtual channel selection; and
rendering the preview as a section of the on-demand program.

57. A method as recited in claim 43, further comprising rendering the preview as a duration of the recorded program corresponding to a beginning of the recorded program.

58. A method as recited in claim 43, further comprising rendering the preview as a section of the recorded program, the section being designated with a preview marker.

59. A method as recited in claim 43, further comprising rendering the preview as one or more sections of the recorded program, the one or more sections being designated with one or more preview markers.

60. A method as recited in claim 43, further comprising:
rendering the preview of the recorded program;
receiving a selectable input to initiate rendering the recorded program; and
rendering the recorded program.

61. A method as recited in claim 43, further comprising:
rendering the preview of the recorded program;
receiving a selectable input to initiate rendering the recorded program; and
rendering an on-demand program as the recorded program.

62. A method as recited in claim 43, further comprising:
rendering the preview of the recorded program;
receiving a selectable input to initiate rendering the recorded program; and
rendering a recorded broadcast program as the recorded program.

63. A method as recited in claim 43, wherein generating includes generating the virtual channel preview guide to display the one or more recorded programs in alphabetical order.

64. A method as recited in claim 43, wherein generating includes generating the virtual channel preview guide to display the one or more recorded programs in a user-selectable order.

65. A method as recited in claim 43, wherein generating includes generating the virtual channel preview guide to display, for each of the one or more recorded programs, a program name, an associated virtual channel number, and at least one of a date when a broadcast program was recorded, a time when a broadcast program was recorded, and a recorded program descriptor.

66. A method as recited in claim 43, further comprising generating a program guide that includes:
a broadcast program identifier and an associated program channel identifier for each of one or more programs scheduled to be broadcast; and
the virtual channel preview guide that includes a recorded program identifier and an associated virtual channel identifier for each of the one or more recorded programs.

67. One or more computer-readable media comprising computer-executable instructions that, when executed, direct a digital video recorder to perform the method of claim 43.

68. One or more computer-readable media comprising computer-executable instructions that, when executed, direct a digital video recorder to:
generate a virtual channel preview guide to display virtual channels and associated recorded programs;
initiate a preview of one or more recorded programs in response to receiving a virtual channel selection.

69. One or more computer-readable media as recited in claim 68, further comprising computer executable instructions that, when executed, direct the digital video recorder to assign a different virtual channel to each of the associated recorded programs.

70. One or more computer-readable media as recited in claim 68, further comprising computer executable instructions that, when executed, direct the digital video recorder to assign a different virtual channel to a group of the associated recorded programs.

71. One or more computer-readable media as recited in claim 68, further comprising computer executable instructions that, when executed, direct the digital video recorder to generate the virtual channel preview guide to display one or more recorded broadcast programs and one or more on-demand programs.

72. One or more computer-readable media as recited in claim 68, further comprising computer executable instructions that, when executed, direct the digital video recorder to generate the virtual channel preview guide to display at least one of a recorded broadcast program and an on-demand program.

73. One or more computer-readable media as recited in claim 68, further comprising computer executable instructions that, when executed, direct the digital video recorder to record a broadcast program and initiate the preview as a section of the broadcast program in response to receiving the virtual channel selection.

74. One or more computer-readable media as recited in claim 68, further comprising computer executable instructions that, when executed, direct the digital video recorder to receive an on-demand program and initiate the preview as a section of the on-demand program in response to receiving the virtual channel selection.

75. One or more computer-readable media as recited in claim 68, further comprising computer executable instructions that, when executed, direct the digital video recorder to render the preview as one or more sections of an on-demand program, the one or more sections being designated with one or more preview markers.

76. One or more computer-readable media as recited in claim 68, further comprising computer executable instructions that, when executed, direct the digital video recorder to render the preview as one or more sections of a recorded broadcast program, the one or more sections being designated with one or more preview markers.

77. One or more computer-readable media as recited in claim 68, further comprising computer executable instructions that, when executed, direct the digital video recorder to render a recorded broadcast program in response to receiving a preview input to display the recorded broadcast program.

78. One or more computer-readable media as recited in claim 68, further comprising computer executable instructions that, when executed, direct the digital video recorder to render an on-demand program in response to receiving a preview input to display the on-demand program.
